(19) United States
(12) Patent Application Publication
(10) Pub. No.: US 2014/0366802 A1
(43) Pub. Date: Dec. 18, 2014

(54) GAS NOZZLE FOR CONTROLLING PLATED MEMBRANE THICKNESS AND HOT-DIP APPARATUS USING SAME

(71) Applicant: HITACHI METALS, LTD., Minato-ku, Tokyo (JP)

(72) Inventors: Motoyuki Itoh, Saitama (JP); Kyoko Takeda, Saitama (JP)

(21) Appl. No.: 14/360,944

(22) PCT Filed: Nov. 26, 2012
(86) PCT No.: PCT/JP2012/080442

§ 371 Date: May 28, 2014

(30) Foreign Application Priority Data
Nov. 28, 2011 (JP) 2011-258885

(51) Int. Cl. C23C 2/18; F26B 21/00

(52) U.S. Cl. CPC C23C 2/185; F26B 21/004
USPC 118/712; 34/218; 118/63

(57) ABSTRACT

The gas nozzle comprises: an outer tube part that is provided in an upright position with respect to the liquid surface of molten metal; an inner tube part provided inside the outer tube part, comprising a cavity inside, through which a wire rod pulled up from the molten metal passes; a void part formed between the outer tube part and the inner tube part; a gas introduction part for introducing gas into the void part; and a jetting port for jetting at least part of the gas introduced by the gas introduction part, via the void part, from one end of the outer tube part towards the liquid surface of the molten metal.

### TECHNICAL FIELD

The present invention relates to a gas nozzle for controlling plated membrane thickness and a hot-dip apparatus that uses the same.

### BACKGROUND ART

As an apparatus for forming hot-dipped layer (hereinafter referred to as a plated layer) on the surface of a metal wire rod, for example, a hot-dip apparatus such as that shown in FIG. 11 is known.

The hot-dip apparatus 80 of FIG. 11 is an apparatus in which a metal wire rod W (hereinafter referred to as wire rod W) proceeding in the direction of arrow A is continuously pulled in to a plating tank 81 in which molten metal L is pooled, then subjected to direction change by a sink roll 82, and continuously pulled up from the liquid surface S of the molten metal L in the direction of arrow B, to form a plated layer on the surface of the wire rod W.

Further, the hot-dip apparatus 80 of FIG. 11 comprises a cover 83 that covers the liquid surface S of the molten metal L around the wire rod W, and an inert gas that prevents oxidation of the liquid surface S is introduced to the interior of the cover 83 from a gas supply source 84 through a piping 85. Further, a heater 86 for preventing temperature decrease of the liquid surface S is provided in the interior of the cover 83, and the inert gas atmosphere inside the cover 83 is heated. A plated layer is formed on the surface of the wire rod W pulled up from the liquid surface S of the molten metal L, and the wire rod W is collected by winding on a reel not shown in the figure.

On the other hand, in the hot-dip apparatus of FIG. 11, it is known that when the wire rod W is pulled up at high speed to increase productivity, the amount of molten metal adhering on the surface of the wire rod W increases, and the thickness of the plated layer becomes thick. This phenomenon is caused by the shape of the meniscus M of the molten metal L formed around the wire rod W. That is, as shown in FIG. 12, compared to a case where the wire rod W is pulled up at low speed (FIG. 12 (a)), when the wire rod W is pulled up at high speed (FIG. 12 (b)), the meniscus M of the molten metal L becomes high, and the amount of molten metal L that adheres to the wire rod W increases, leading to the thickening of the plated layer.

Thus, in a hot-dip apparatus as shown in FIG. 11, generally, gas is blown on to the surface of the wire rod W or an electromagnetic force is operated to remove the adhering excessive molten metal, to thereby inhibit the plated layer from becoming thick. Meanwhile, in the following Patent Documents, methods for controlling the membrane thickness of the plated layer by the shape of the meniscus M of the molten metal L are disclosed.

In Patent Document 1, in a hot-dipping method of introducing a wire to be plated into a plating bath and leading it out to a non-oxidizing gas atmosphere, to thereby form a continuous plated layer on the periphery of the wire, a method of spirally stirring the plating bath from which the wire is led out, while leading the wire out from the center of the spiral of the plating bath in a direction opposite to the gravitational direction, is disclosed. In this method of hot dipping, the shape of the meniscus M is controlled by stirring the plating bath in a spiral manner to concave the center of the spiral in the plating bath, and the liquid surface of the plating bath is utilized as a fluid restriction tool. Since the height of the concave at the center of the spiral can be changed by changing the rotation speed of stirring in the plating bath, it is said that a thin plated layer can be formed by easy operation.

Further, Patent Document 2 discloses a hot-dipping method of forming a plated layer by continuously soaking a metallic wire rod in a plating bath that pools a plating liquid, wherein the part where the wire rod is pulled upward from the liquid surface of the plating bath is surrounded by a strain surface-forming tube, while the strain surface-forming tube is formed with a certain inner diameter, so that the liquid surface surrounded by the strain surface-forming tube does not have a horizontal surface. According to the results shown in Table 1 of Patent Document 2, even when the line speed (the speed at which the wire rod is pulled up) is increased, by choosing the appropriate material and inner diameter for the strain surface-forming tube, the plated layer can be controlled to be thin.

Furthermore, as a method of suppressing the formation of thick plated layers, Patent Document 3 discloses a method of producing Al plated steel wire, wherein a steel wire soaked in molten Al plating bath is continuously pulled up in to a vapor phase atmosphere to provide a molten Al plate on the surface of a steel wire. In this method, in a plane that includes the axis of the steel wire that is pulled up from the bath surface, a state in which a difference in liquid surface height exists on both horizontal sides of the steel wire is created, and the steel wire is pulled up while maintaining this state. According to the method of Patent Document 3, an Al-plated steel wire of small diameter with plenty of plate adhered can be produced efficiently.

### RELATED ART DOCUMENT

### Patent Documents

[Patent Document 1] JP-A-H6-081106
[Patent Document 2] JP-A-2010-248589
[Patent Document 3] JP-A-2011-084792

### SUMMARY OF THE INVENTION

### Problem to be Solved by the Invention

The methods of Patent Documents 1 and 2 are methods for forming thin plated layers, and it is believed that the plated layer can be controlled so that it does not become thick, even when the wire rod is pulled up at high speed. However, when such methods are used industrially, the following problems arise.

In the method of Patent Document 1, since the wire rod is placed at the center of the spiral of the molten metal, if the wire rod is a foil sheet, the spiral would not affect the wire rod evenly, and may cause irregularities in the plated layer thickness. Further, in this method, the wire rod may become twisted due to the spiral, and thus, the wire rod may have to be pulled up while adding tension. When tension is added to the wire rod, the wire rod may break or flexibility may be lost due to work-hardening of the wire rod, which could become problematic.

Further, in the method of Patent Document 2, an optimum strain surface-forming tube may have to be prepared for each plating condition. In addition, time-dependent changes in the molten metal composition and in the state of the interior of the strain surface-forming tube are inevitable, which may cause the controlling of membrane thickness to be unstable.

The present invention was made in view of the above-described problems of the prior art, and provides a gas nozzle for controlling plated membrane thickness that is used in hot-dipping of wire rods, and a hot-dip apparatus using same, which can control the membrane thickness of the plated layer to be thin, even when the wire rod is pulled up at high speed.

### Means for Solving the Problems

The gas nozzle of the first invention is a gas nozzle for controlling plated membrane thickness that is used in hot-dipping of wire rods, which comprises: an outer tube part that is provided in an upright position with respect to the liquid surface of a molten metal; an inner tube part that is installed inside the outer tube part and comprises a cavity inside, through which the wire rod pulled up from the molten metal passes; a void part formed between the outer tube part and the inner tube part; a gas introduction part for introducing gas into the void part; and a jetting port for jetting at least part of the gas that is introduced from the gas introduction part, via the void part, from one end of the outer tube part towards the liquid surface of the molten metal.

Further, the gas nozzle for controlling plated membrane thickness comprises a wire rod lead-out port on the other end of the outer tube, wherein at least part of the gas introduced from the gas introduction part is discharged to the wire rod lead-out port, via the void part. In this case, it is preferable that the gas passage resistance from the gas introduction part to the jetting port is smaller than the gas passage resistance from the gas introduction part to the wire rod lead-out port.

Furthermore, the gas nozzle for controlling plated membrane thickness may comprise a straightening plate with multiple holes in the void part between the gas introduction part and the one end. Further, the straightening plate with multiple holes may be installed on both the jetting port side and the wire rod lead-out port side, with respect to the gas introduction part.

Further, in the gas nozzle for controlling plated membrane thickness, the gas introduction part may comprise a first gas introduction part and a second gas introduction part; the void part may be partitioned to a jetting port side and a wire rod lead-out side; gas may be introduced from the first gas introduction part to the void part of the jetting port side; and gas may be introduced from the second gas introduction part to the void part of the wire rod lead-out port side. In this case, it is preferable that straightening plates with multiple holes are installed between the first gas introduction part and the one end, and between the second gas introduction part and the other end.

Furthermore, the hot-dip apparatus for wire rods of the second invention comprises: the gas nozzle for controlling plated membrane thickness of the first invention, provided in an upright position with the jetting port facing the liquid surface of the molten metal; a gas supply means for supplying gas to the gas introduction part of the gas nozzle for controlling plated membrane thickness; wherein the wire rod pulled up from the molten metal passes through the cavity inside the inner tube part, and the gas jetted from the jetting port presses the meniscus of the molten metal around the wire rod.

In this case, it is preferable that the gas supply means comprises a gas temperature adjustment means.

Further, the hot-dip apparatus may comprise a gas jetting height detection means for detecting gas jetting port height of the gas nozzle for controlling plated membrane thickness, with respect to the liquid surface of the molten metal.

The gas introduction part may comprise a first gas introduction part and a second gas introduction part; the void part may be partitioned into a jetting port side and a wire rod lead-out side; gas may be introduced from the first gas introduction part to the void part of the jetting port side, and gas may be introduced from the second gas introduction part to the void part of the wire rod lead-out side; and may comprise a differential pressure detection means for detecting the pressure difference between the pressure of the gas introduced from the first gas introduction part and the pressure of the gas introduced from the second gas introduction part.

### Advantageous Effect of the Invention

The gas nozzle for controlling plated membrane thickness that is used in hot-dipping of wire rods of the present invention can jet equalized gas against the meniscus of the molten metal around the wire rod, and allows the formation of plated layer by uniformly pressing down on the meniscus of the molten metal from above. Thus, the plated layer can be thinned so that the mount of molten metal adhered on the surface of the wire rod can be uniformly reduced. Further, the hot-dip apparatus that utilizes this gas nozzle can control the membrane thickness so that the plated layer is thinly formed, even when the wire rod is pulled up at high speed.

### BRIEF DESCRIPTION OF THE DRAWINGS

FIG. 1 is a schematic diagram that shows one example of the wire rod hot-dip apparatus of the present invention.

FIG. 2 is a drawing that shows one example of the cross-sectional form of the gas nozzle of the present invention.

FIG. 3 is a drawing that describes the state in which the gas, jetted from the gas nozzle of the present invention, affects the meniscus of the molten metal formed around the wire rod.

FIG. 4 is a drawing that shows another example of the cross-sectional form of the gas nozzle of the present invention.

FIG. 5 is a drawing that shows another example of the cross-sectional form of the gas nozzle of the present invention.

FIG. 6 is a drawing that shows another example of the cross-sectional form of the gas nozzle of the present invention.

FIG. 7 is a drawing that shows another example of the cross-sectional form of the gas nozzle of the present invention.

FIG. 8 (a), (b) are drawings that show another example of the cross-sectional form of the gas nozzle of the present invention.

FIG. 9 is a diagram that shows the relationship between the total thickness of the plated foil sheet and the gas flow rate, when the gas nozzle of the present invention is used.

FIG. 10 is a diagram that shows the relationship between the total thickness of the plated foil sheet and the pull-up speed of the wire rod, when the gas nozzle of the present invention is used.

FIG. 11 is a drawing that describes a conventional wire rod hot-dip apparatus.

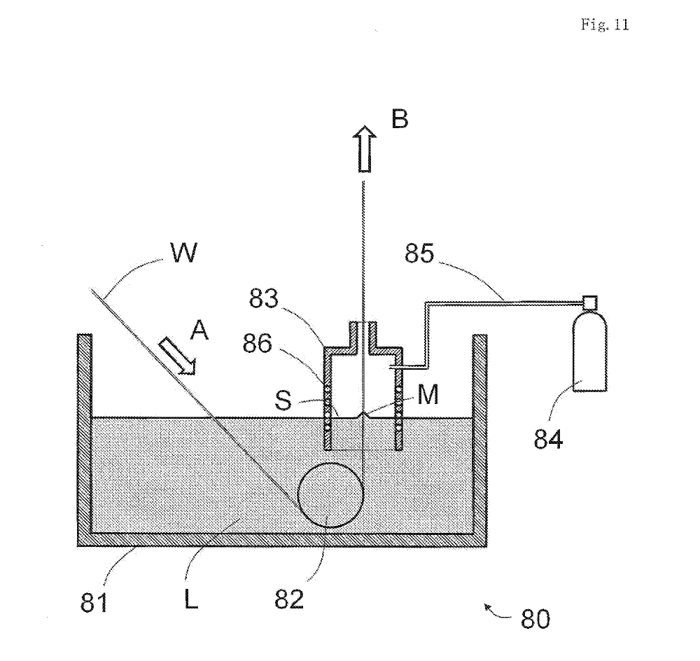

FIG. 12 is a drawing that describes the difference in the meniscus shape of the molten metal that forms around the wire rod, according to the pull-up speed.

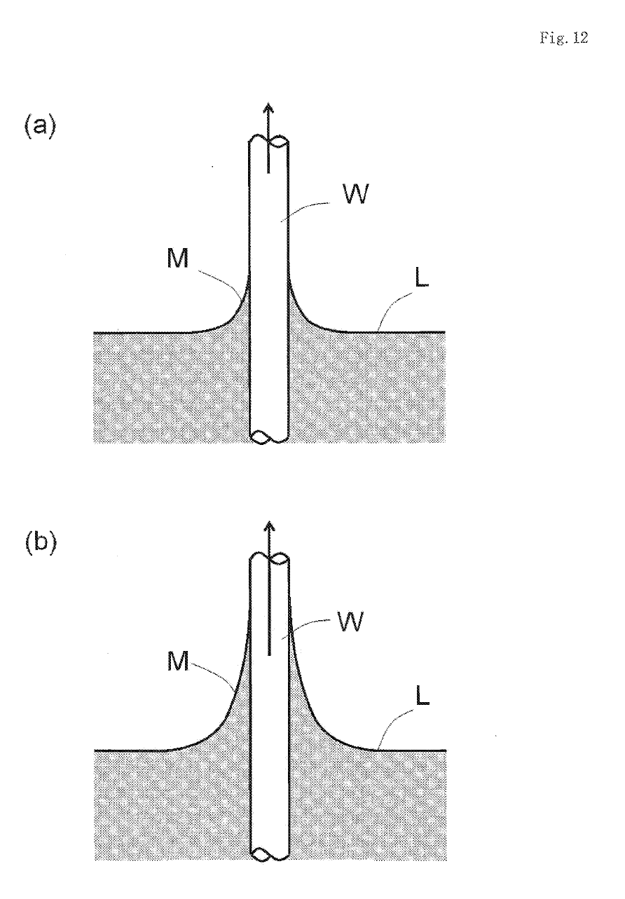

### DESCRIPTION OF PREFERRED EMBODIMENTS OF THE INVENTION

Hereinafter, embodiments of the gas nozzle and the hot-dip apparatus of the present invention will be described with reference to the accompanying figures.

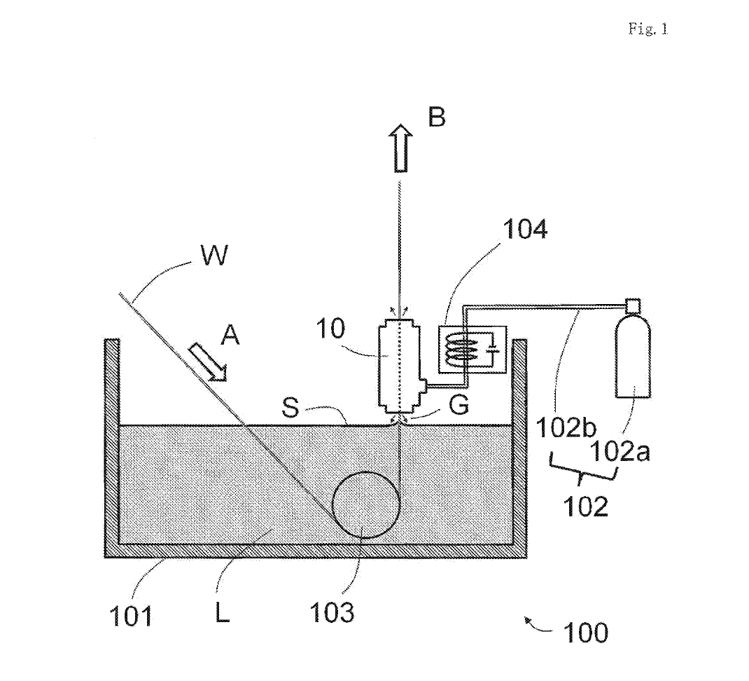

FIG. 1 shows one example of an embodiment of the hot-dip apparatus of the present invention, with the composition of the gas nozzle abbreviated. The hot-dip apparatus 100 comprises a plating tank 101 for pooling molten metal L, a cylindrical gas nozzle 10 with openings on both ends provided above the molten metal L, and a gas supply means 102 for supplying gas G to the gas nozzle 10.

The hot-dip apparatus 100 forms a plated layer on the surface of wire rod W by continuously pulling in the wire rod W, which proceeds in the direction of arrow A, in to the plating tank 101 in which molten metal L is pooled, subjecting it to a direction change by the sink roll 103, and continuously pulling it up from the liquid surface S of the molten metal L in the direction of arrow B.

Further, the wire rod W is passed through the gas nozzle 10, which is provided above the molten metal L, after being continuously pulled up from the liquid surface S, and is pulled upward. The gas nozzle 10 jets gas G that is supplied from the gas supply means 102 (which includes the gas supply source 102a and the piping 102b) from the bottom opening of the gas nozzle 10.

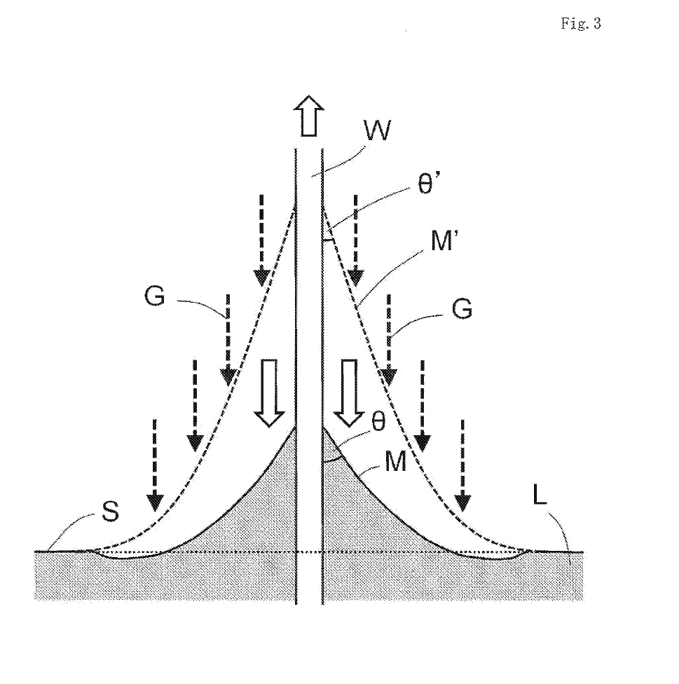

Here, as shown in FIG. 3, the gas G that is jetted from the bottom opening of the gas nozzle 10 presses the entire meniscus M of the molten metal L from above, and lowers the height of the liquid surface from M′ to M, to thereby increase its contact angle with the wire rod W from θ′ to θ. This effect causes the molten metal L to easily undergo shearing deformation on the entire outer circumferential surface of the wire rod W, and becomes less likely to adhere to the wire rod W to be pulled up, leading to the thinning of the plating layer.

Note that the gas G, which is jetted from the gas nozzle 10 of the present embodiment, is preferably heated moderately, so that the liquid surface temperature of the molten metal L does not decrease too much. Thus, the gas supply means 102 may comprise a heating function such as a heater 104, so that heated gas G is supplied to the gas nozzle 10.

On the other hand, the gas G supplied to the gas nozzle 10 also has a cooling effect of solidifying the molten metal L adhered to the wire rod W within the gas nozzle 10. Thus, supplying gas G that is overly heated is undesirable, because it delays the solidification of molten metal L, and may lead to a fall in productivity. For example, in a case where the gas supply means 13 is heated by the radiant heat of the molten metal L, the gas G may be heated excessively causing solidification of the molten metal L on the surface of the wire rod W to become difficult. In such case, it is preferable to provide a cooling function in the gas supply means 13 to cool the gas G to a moderate temperature and supply to the gas nozzle 10.

Lastly, wire rod W is pulled above the gas nozzle 10, wound by a reel etc., and collected. Note that in FIG. 1, the means for winding the wire rod W to a reel etc., and the means for heating and melting the molten metal L are abbreviated from the figure.

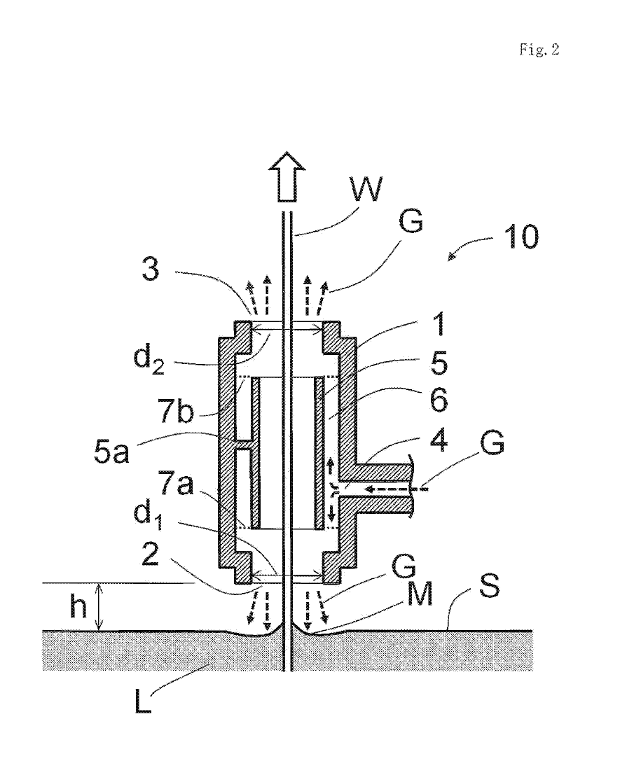

FIG. 2 shows one example of the cross-sectional form of the gas nozzle of the present invention. The gas nozzle 10 of the present embodiment is a hollow body comprising an outer tube part 1 and an inner tube part 5; the outer tube part 1 and the inner tube part 5 are connected via a support part 5a, and a void part 6 is formed between the outer tube 1 part and the inner tube part 5. Further, in the outer tube part 1, a jetting port 2, which is also the insertion port for the wire rod, is provided on one end (bottom end), and a wire rod lead-out port 3, which is also the discharge port for the gas G, is provided on the other end (upper end). In the hot-dip apparatus 100, this gas nozzle 10 is provided in an upright position above the molten metal L, with the jetting port 2 facing the meniscus M of the molten metal L that forms around the wire rod W with a distance h.

Furthermore, the gas nozzle 10 of the present embodiment comprises a gas introduction part 4 for introducing gas from the side wall of the outer tube part 1, and the gas G supplied from the gas supply means 102 is introduced to the void part 6 from the gas introduction part 4. Note that in FIG. 2, the jetting port 2 and the wire rod lead-out port 3 are shown with the opening diameters largely exaggerated for better understanding of the drawing.

In the gas nozzle 10 of the present embodiment, an inner tube part 5 is provided inside the outer tube part 1, and the wire rod W is inserted through the cavity inside the inner tube part 5. Thus, the inner tube part 5 has a function of shielding the wire rod W so that the gas G that is introduced from the gas introduction part 4 is not directly jetted on to the wire rod W. Because of this function, in the gas nozzle 10 of the present embodiment, the gas G can be jetted from the jetting port 2, while vibration of the wire rod due to the flow of gas G can be suppressed. When the vibration of the wire rod W is suppressed, the meniscus M of the molten metal L is stably formed, and irregularities in the membrane thickness of the plating layer is less likely to occur.

Here, for the shielding by the inner tube part 5 to be more effective, it is preferable that the top end and the bottom end of the inner tube part 5 are installed away from the gas introduction part 4, and it is desirable for the gas introduction part 4 to be arranged at a height mid-distance from the top end and the bottom end of the inner tube part 5.

Further, the above shielding effect can also be obtained by placing a plate-shaped shield between the wire rod W and the gas introduction part 4, in place of the inner tube part 5. However, since the inner tube part 5 of the present embodiment is installed so that it surrounds part of the wire rod W, the gas G that is introduced form the gas introduction part 4 is diffused along the outer surface of the inner tube part 5. Thus, the gas G inside the void part 6 can be quickly regulated by the inner tube part 5, and jetted from the jetting port 2. For this reason, the meniscus M of the molten metal L can be pressed uniformly from above to enable even thinning of the plated layer. In order to regulate the gas G quickly, it is preferable that the outer wall of the inner tube part is a smooth curved surface like the outer wall of a cylinder.

Further, although in the gas nozzle 10 of the present embodiment, the inner tube part 5 is installed inside the outer tube part 1 in the longitudinal direction of the gas nozzle, the inner tube part 5 may be arranged so that at least one end protrudes from the top and/or bottom of the outer tube part 1. When the inner tube 5 is arranged in such manner, the shielding of the inner tube part 5 becomes more effective, and the vibration of the wire rod W is further suppressed, so that irregularities of the membrane thickness of the plated layer does not occur, allowing control of the membrane thickness of the plated layer.

Further, it is preferable that the gas G introduced from the gas introduction part 4 is jetted out of the jetting port 2 through a straightening plate 7a, and discharged to the wire rod lead-out port 3 through a straightening plate 7b, by installing straightening plates 7a, 7b with multiple holes in the void part 6 between the outer tube part 1 and the inner tube part 5.

By installing the straightening plate 7a, a straightened gas G that passes through the straightening plate 7a can be jetted from the jetting port 2, and vibration of the wire rod W can further be suppressed, and irregularities in the membrane thickness of the plated layer becomes less likely to occur. In addition, since a straightened gas G can be jetted from the jetting port 2, the meniscus M of the molten metal L can be pressed from above with a more regulated gas flow, and the plated layer can be further thinned evenly.

Furthermore, by installing the straightening plate 7b, the gas G passes through the straightening plate 7b and a more straightened gas G can be discharged to the wire rod lead-out port 3, thus enabling suppression of the vibration of the wire rod, and irregularities in the membrane thickness of the plated layer becomes less likely to occur.

Further, by installing both straightening plate 7a and straightening plate 7b, the pressure of the gas G before passing through straightening plates 7a, 7b increases (in other words, a pressure difference occurs between the inside and the outside of the void part 6 surrounded by the straightening plates 7a, 7b), and gas G can be discharged evenly from all of the multiple holes. Thus, gas G that is further straightened can be flowed to the jetting port 2 or the wire rod lead-out port 3.

Furthermore, in the gas nozzle 10 of the present embodiment, part of the gas G is discharged to the wire rod lead-out port 3, from which the wire rod W that is inserted to the gas nozzle 10 is pulled out to the outside of the gas nozzle 10, from the void part 6. However, the gas G that is discharged to the wire rod lead-out port 3 hardly contributes to the formation of the thinned plated layer. Thus, it is preferable that more gas G introduced from the gas introduction part 4 is jetted from the jetting port 2. By such gas flow, the gas G introduced to the gas nozzle 10 is more effectively used in the control of the membrane thickness of the plated layer, and the amount of gas introduced to the gas nozzle 10 and the amount of gas jetted from the jetting port 2 becomes closer, allowing better control of the gas G jetted from the jetting port 2, and making membrane thickness control of the plated layer easier.

Hereinafter, an embodiment of the gas nozzle of the present invention, wherein the gas G introduced from the gas introduction part 4 is designed to be jetted out more from the jetting port 2, will be described.

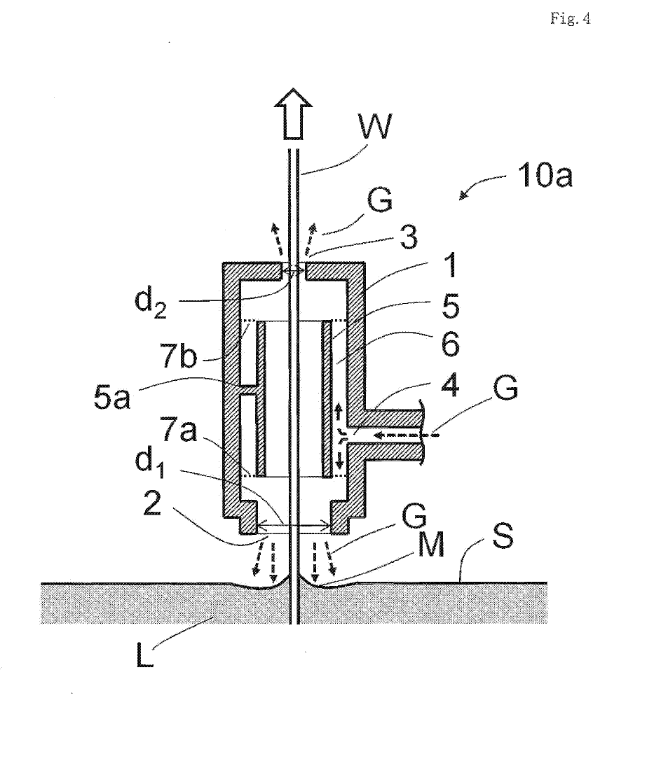

FIG. 4 shows another example of the cross-sectional form of the gas nozzle of the present invention, and the notations 1-7b of the gas nozzle 10a of the present embodiment correspond to the notations 1-7b of the gas nozzle 10 of FIG. 2. Further, the jetting port 2 and the wire rod lead-out port 3 in FIG. 4 are also shown largely exaggerated for better understanding of the drawing.

In the gas nozzle 10a of the present embodiment, the opening diameter d1 of the jetting port 2 is made larger than the opening diameter d2 of the wire rod lead-out port 3, and the opening area of the jetting port 2 is made larger than the opening area of the wire rod lead-out port 3. By taking such form, the passage resistance of the gas from the gas introduction part 4 to the jetting port 2 is made smaller than the passage resistance of the gas from the gas introduction part 4 to the wire rod lead-out port 3. Thus, it becomes more difficult for the gas G to be discharged to the wire rod lead-out port 3, and more gas G introduced from the gas introduction part 4 can be jetted more efficiently from the jetting port 2.

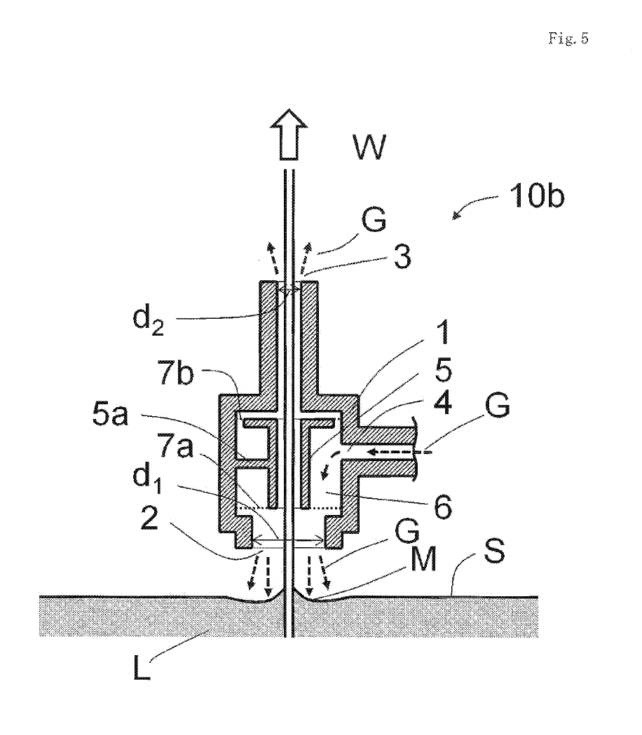

FIG. 5 also shows another example of the cross-sectional form of the gas nozzle of the present invention, and the notations 1-7b of the gas nozzle 10b of the present embodiment also correspond to the notations 1-7b of the gas nozzle 10 of FIG. 2. Note that the jetting port 2 and the wire rod lead-out port 3 in FIG. 5 are also shown largely exaggerated for better understanding of the drawing.

In the gas nozzle 10b of the present embodiment, the opening diameter d1 of the jetting port 2 is made larger than the opening diameter d2 of the wire rod lead-out port 3, and the passage for the gas G through the wire rod lead-out port 3 is made to be narrower and longer than the passage for the gas G through the jetting port 2 (that is, the inner diameter of the outer tube part 1 is reduced on the wire rod lead-out port 3 side). By adopting such form, the passage resistance of the gas from the gas introduction part 4 to the jetting port 2 can be made smaller than the passage resistance of the gas from the gas introduction part 4 to the wire rod lead-out port 3. Thus, it becomes more difficult for the gas G to be discharged to the wire rod lead-out port 3, and more gas G introduced from the gas introduction part 4 can be jetted more efficiently from the jetting port 2.

Further, in the gas nozzle 10b of FIG. 5, the straightening plates are installed so that the total sum of the hole area of the straightening plate 7a on the jetting port 2 side is larger than the total sum of the hole area of the straightening plate 7b on the wire rod lead-out port 3. By using such straightening plates 7a, 7b, the passage resistance of the gas from the gas introduction part 4 to the jetting port 2 can be made smaller than the passage resistance of the gas from the gas introduction part 4 to the wire rod lead-out port 3. Thus, it becomes more difficult for the gas G to be discharged to the wire rod lead-out port 3, and more gas G introduced from the gas introduction part 4 can be jetted more efficiently from the jetting port 2.

Moreover, as an example of a gas nozzle in which the gas G introduce from the gas introduction part 4 is jetted efficiently from the jetting port 2, in the gas nozzle 10 of FIG. 2, the void part 6 on the wire rod lead-out port 3 side can be covered more than the gas introduction part 4. In a gas nozzle of such form, more gas G introduced from the gas introduction part 4 can be jetted efficiently from the jetting port 2, and a gas nozzle with good controllability of the jetting gas G can be obtained.

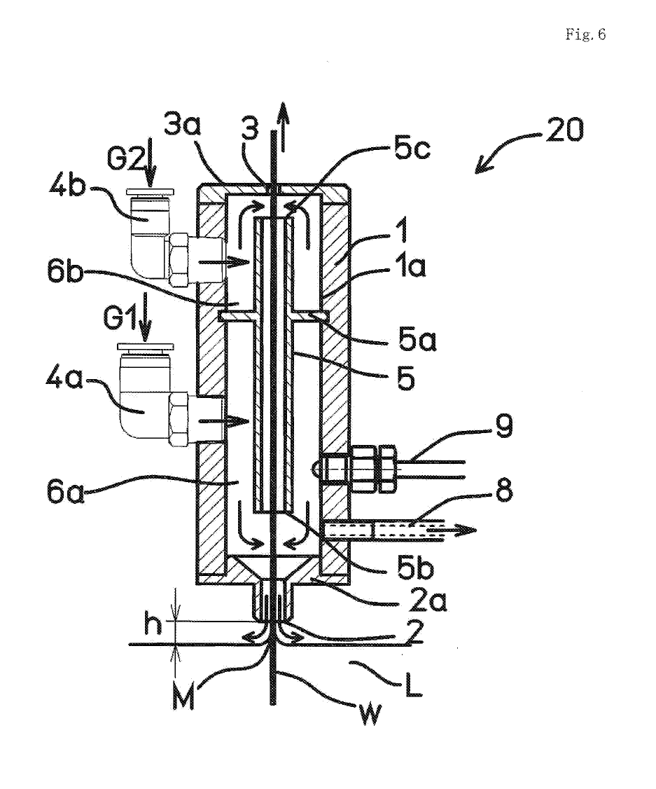

Next, another embodiment of the gas nozzle of the present invention, with a gas introduction method that differs from those of gas nozzles 10, 10a, and 10b will be described. FIG. 6 shows one example of the cross-sectional form of such embodiment.

The gas nozzle 20 of the present embodiment is a hollow body that comprises an outer tube part 1 and an inner tube part 5, wherein the outer tube part 1 and the inner tube part 5 are connected via a flange-shaped support part 5a, and void parts 6a, 6b are formed between the inner tube part 1 and the outer tube part 5. Further, in the outer tube part 1, to one end (bottom end) is joined a bottom cap 2a, and to the other end (top end) is joined a top cap 3a. The jetting port 2 opens at the center of the bottom cap 2a, and the wire rod lead-out port 3 opens at the center of the top cap 3a. Such a gas nozzle 20 is provided in an upright position to the molten metal L with the jetting port 2 facing the meniscus M of the molten metal L formed around the wire rod W with a distance h, in a hot-dip apparatus 100.

Further, in the gas nozzle 20 of the present embodiment, the flange-shaped support part 5a that connects the outer tube part 1 and the inner tube part 5 separates the void between the outer tube part 1 and the inner tube part 5 into void part 6a and void part 6b. Gas introduction parts 4a and 4b are provided on void part 6a and void part 6b, respectively, to introduce gas from the side wall of outer tube 1.

In such a gas nozzle 20, the inner structure allows the gas G1 introduced to the void part 6a from the gas introduction part 4a to be jetted towards the liquid surface of molten metal L from the jetting port 2, while enabling the cavity of the inner tube part 5 to be pressurized upwardly from the bottom end 5b of the inner tube part 5. Further, the inner structure allows the gas G2 introduced from the gas introduction part 4b to the void part 6b to be discharged to the wire rod lead-out port 3, while enabling the cavity of the inner tube part 5 to be pressurized downwardly from the top end 5c of the inner tube part 5.

Furthermore, the gas nozzle 20 of the present embodiment is installed with an extraction tube 8 and a temperature sensor 9 on the side near one end (bottom end) of the outer tube part 1. The extraction tube 8 enables sampling part of the gas in the void part 6a. Further, the temperature sensor 9 enables measurement of the temperature inside the gas nozzle 20. The structure enables controlling the oxygen concentration in the gas jetted from the jetting port 2 by connecting the extraction tube 8 to an oxygen analyzer (not shown in the figure), and enables monitoring the temperature of the gas jetted from the jetting port 2 by using the temperature sensor 9.

Next, the functions of the gas nozzle 20 will be described. As described previously, the gas nozzle 20 comprises gas introduction parts 4a, 4b in each void parts 6a, 6b. Thus, gas can be introduced to void parts 6a, 6b from both gas introduction parts 4a, 4b.

The gas G1 introduced to the void part 6a from the gas introduction part 4a is jetted towards the molten metal L from the jetting port 2. Meanwhile, by introducing gas G2 from the gas introduction part 4b, the gas G2 flows upward within the void part 6b and flows toward the wire rod lead-out port 3.

Here, part of the gas G1 that is introduced from the gas introduction part 4a flows upward inside the inner tube part 5, and tries to flow toward the wire rod lead-out port 3. Further, part of the gas G2 introduced to the gas introduction part 4b flows downward inside the inner tube part 5, and tries to flow toward the jetting port 2. By adjusting the gas pressure of gas G1 and gas G2, the upward flow of gas G1 the inside inner tube 5 and the downward flow of gas G2 inside the inner tube 5 can be balanced. For this reason, the upward and downward flow of gas inside the inner tube 5 can be canceled out, and all of the gas G1 introduced from the gas introduction part 4a can be jetted from the jetting port 2. Thus, even when expensive gases such as Ar and He are to be jetted as the gas G1 against the liquid surface of the molten metal L, by using inexpensive gas, such as air, as gas G2, most of the gas discharged from the wire rod lead-out port 3 can be the less expensive gas G2. Hence, by using the gas nozzle 20 of the present embodiment, the amount of gas G1 discharged from the wire rod lead-out port 3 can be suppressed and the expensive gas G1 can be used efficiently for controlling the membrane thickness of the plated layer.

Note that the gas flow inside the inner tube part 5 can be canceled out by balancing gas G1 and G2 inside the inner tube part 5, just by confirming the balance of the gases G1 and G2. For example, when Ar is introduced as the gas G1 from the gas introduction part 4a and air is introduced as the gas G2 from the gas introduction part 4b, by sampling a small amount of gas from the extraction tube 8 and measuring its oxygen concentration, the balance of gases G1 and G2 can be determined. That is, if the oxygen concentration of the sampled gas is higher than the original oxygen concentration of gas G1, the pressure of the gas G2 is higher than the pressure of gas G1, and it can be determined that a downward gas flow exists inside the inner tube part 5. If the oxygen concentration of the sampled gas is equal to the original oxygen concentration of gas G1, it can be determined that the opposite situation exists.

Further, in an example where the gas G1 is Ar and the gas G2 is air, an example of the specific procedure for balancing the gas G1 and the gas G2 will be described. First, the introduction pressure of Ar, which is gas G1, is fixed as the standard, and the introduction pressure of air, which is gas G2, is changed while monitoring the measured value of the oxygen concentration. Then, when the oxygen concentration drastically increases from the original oxygen concentration of the gas G1, it can be determined that a downward gas flow has occurred inside the inner tube part 5. From such change in oxygen concentration, by setting the introduction pressure of air so that it is slightly lower than the introduction pressure when the downward gas flow occurred inside the inner tube part 5, Ar introduced from the gas introduction part 4a can be efficiently jetted from the jetting port 2 without being discharged from the wire rod lead-out port 3. From the above-described procedure, most of the gas G1 introduced from the gas introduction part 4a can be jetted from the jetting port 2, while most of the gas G2 introduced from the gas introduction part 4b is discharged to the wire rod lead-out port 3.

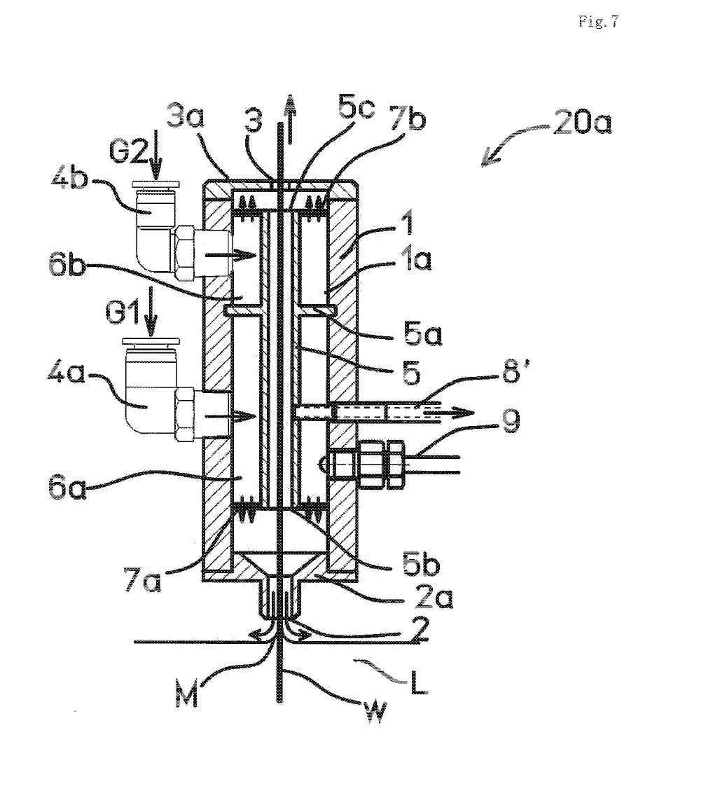

Furthermore, FIG. 7 shows another example of the cross-sectional form of the gas nozzle of the present invention. Note that in the gas nozzle 20a of the present figure, for parts that are the same as those shown in the gas nozzle 20 of FIG. 6, the same notations are given.

The difference between the gas nozzle 20a of the present embodiment and the gas nozzle 20 of FIG. 6 is that in gas nozzle 20a, an extraction tube 8′ opens and connects to the side of the inner tube part 5, and straightening plates 7a, 7b with multiple through holes are installed on the outer peripheral side of the bottom end 5b and top end 5c of the inner tube part 5, so as to reach the inner wall 1a of the outer tube part 1. In the gas nozzle 20a, the extraction tube 8′ is installed so that it opens at the side of the inner tube part 5, and thus, the boundary between the gases G1 and G2 (the boundary of oxygen concentration) inside the inner tube part 5 can be grasped with high precision, allowing easy and precise balancing of gas G1 and gas G2.

Further, since straightening plates 7a, 7b are installed in the gas nozzle 20a, the flow of gas G1, G2 can be regulated downstream of the straightening plates 7a, 7b; thus, the vibration of the wire rod W can be suppressed, and the occurrence of irregularities in the plated layer can be avoided. Further, by regulating the flow of gases G1, G2, the balanced state of gases G1 and G2 inside the inner tube part 5 stabilizes, and an effect of better controllability of the gas can be realized.

Note that the total sum of the cross-sectional area of the through holes in the straightening plates 7a and 7b are preferably smaller than the cross-sectional areas of the void part 6a and void part 6b, respectively. By installing such straightening plates, the pressures of gases G1 and G2 upstream of the straightening plates 7a, 7b increase, and the flow of gases G1, G2 downstream of the straightening plates 7a, 7b can be further regulated and straightened.

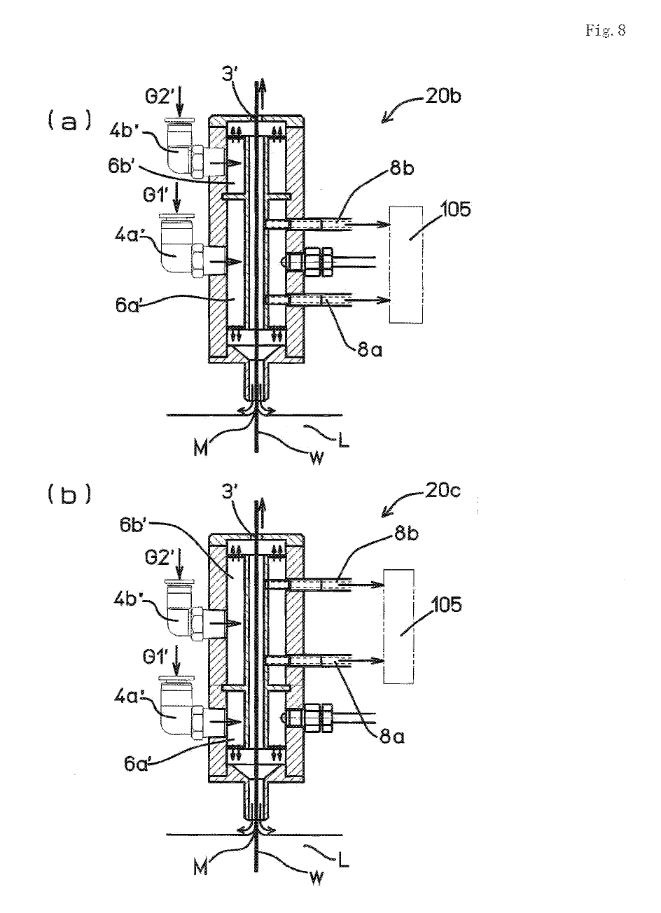

Further, FIG. 8 also shows one example of another cross-sectional form of the gas nozzle of the present invention. Note that in the gas nozzles 20b, 20c of the present figure, for parts that are the same as those shown in the gas nozzle 20 of FIG. 6, the same notations are given.

The difference between the gas nozzles 20b, 20c of the present embodiment and the gas nozzle 20 of FIG. 6 and the gas nozzle 20a of FIG. 7 is that in gas nozzles 20b, 20c, two extraction tubes 8a, 8b open and connect to the side of the inner tube part 5. Note that in the gas nozzle 20b of FIG. 8(a), the two extraction tubes 8a, 8b penetrate the void part 6a′. Further, in the gas nozzle 20c of FIG. 8(b), the two extraction tubes 8a, 8b penetrate the void part 6b′. The other end of the extraction tubes 8a, 8b of each of gas nozzle 20b, 20c that do not connect to the inner tube part 5 are either connected to a differential pressure gauge 105 that measures the pressure difference between the two, or each extraction tube 8a, 8b are connected independently to oxygen analyzers or pressure gauges (not shown in the figure).

In the gas nozzle 20b, 20c of the present embodiment, when the extraction tubes 8a, 8b are connected to a differential pressure gauge 105, by adjusting the introduction pressure of gases G1′ and G2′ introduced to each of void part 6a′ and 6b′, so that the differential pressure gauge shows a pressure difference of zero, the gas flow in the cavity (the opening between the extraction tube 8a, 8b) inside the inner tube part 5 can be canceled out, and gases G1′ and G2′ can be balanced.

Further, when each extraction tube 8a, 8b are connected independently to pressure gauges, the introduction pressure of the gases G1′ and G2′ introduced to the void part 6a′ and the void part 6b′, respectively, can be controlled so that the values of both pressure gauges are the same, to thereby cancel out the gas flow in the cavity inside the inner tube part 5, and gases G1′ and G2′ can be balanced.

Further, when each extraction tube 8a, 8b are connected independently to oxygen analyzers, the introduction pressure of the gas G1′ and G2′ introduced to the void part 6a′ and the void part 6b′, respectively, can be controlled so that a gas of the same oxygen concentration as the gas G1′ introduced to the void part 6a′ can be detected from extraction tube 8a, and a gas of the same oxygen concentration as the gas G2′ introduced to the void part 6b′ can be detected from extraction tube 8b, to thereby cancel out the gas flow in the cavity inside the inner tube part 5, and gas G1′ and gas G2′ can be balanced.

The gas nozzles 20b, 20c enables grasping the existence of a boundary of gas G1′ and gas G2′ between the openings of the extraction tubes 8a, 8b inside the inner tube part 5, by any of the above-described methods. Thus, gases G1′ and G2′ can easily be balanced with high precision, and most of the gas G1′ introduced from the gas introduction part 4a′ can be jetted from the jetting port 2.

Note that although in the gas nozzles 20b, 20c of the present embodiment, the extraction tubes 8a, 8b are provided so that one space of either void part 6a′ or void part 6b′ is penetrated, they may be installed so that the extraction tube 8a penetrates the void part 6a′, and the extraction tube 8b penetrates the void part 6b′, and opens and connects to the side of inner tube part 5.

Although the gas nozzle of the present invention has been described with embodiments of gas nozzle 10, 10a, 10b, 20, 20a, 20b, 20c as examples, it is not necessary for the gas nozzle of the present invention, including such embodiments, to jet a large amount of gas vigorously, as with a gas-wiping nozzle, which wipes away molten metal adhered to wire rods. Only a small amount of gas, just enough to press down and deform the meniscus of the molten metal, is needed to be jetted. Jetting a large amount of gas may cause the molten metal to splash from the liquid surface or the wire rod surface to re-adhere to the surface of the wire rod that has already been pulled up and cause defects, and thus, is not desirable in the gas nozzle of the present invention. For example, it is preferable that the gas pressure and gas flow rate of the gas jetted from the tip of the gas nozzle does not cause ripples on the surface of the molten metal L.

Here, whether ripples of the molten metal L occur or not also depends on the distance between the tip of the gas nozzle and the molten metal L. When the tip of the gas nozzle and the molten metal L are too close, the molten metal L may adhere to the gas nozzle with a small change in gas flow rate etc. Further, if the distance between the tip of the gas nozzle and the molten metal L is too far, the effect of pressing the meniscus becomes small, and a larger amount of gas would be necessary. Thus, the distance between the tip of the gas nozzle and the surface of the molten metal L should preferably be about 2-10 mm (or more preferably, about 3-6 mm). Thus, in the present invention, the gas pressure and gas flow should be set so that ripples do not occur on the surface of the molten metal L when the distance between the tip of the gas nozzle and the surface of the molten metal L is set to be about 2-10 mm.

Further, it is preferable that the shape of the jetting port of the gas nozzle of the present invention corresponds to the cross-sectional shape of the wire rod that is pulled up. The gas nozzle with such a jetting port is preferable for economically controlling the membrane thickness of the plated layer, since it can control the meniscus shape of the molten metal with a small jetting amount of gas. For example, the shape of the jetting port is preferably of a circular opening for a wire rod with a circular cross-section, and of a rectangular opening for a wire rod with a rectangular cross-section. Further, by making the shape of the jetting port long and narrow along the wire rod, gas that is more regulated can be concentrated and jetted to the meniscus of the molten metal, and would thus be more preferable in controlling the membrane thickness of the plated layer economically.

Furthermore, in the gas nozzle of the present invention, to form a uniform plated layer on the surface of a wire rod, it is more preferable that the gas can be jetted symmetrically with the wire rod as the axis, against the meniscus of the molten metal formed around the wire rod. For this matter, it is preferable that the wire rod is pulled up from the liquid surface of the molten metal in a vertically upward direction, and that the gas is jetted from the jetting port of the gas nozzle in a vertically downward direction, i.e., perpendicular to the liquid surface of the molten metal.

Further, in a hot-dip apparatus that utilizes the gas nozzle of the present invention, the height (distance) of the jetting port of the gas nozzle with respect to the liquid surface of the molten metal is preferably constant. When the height of the jetting port of the gas nozzle with respect to the liquid surface of the molten metal changes, the state at which the gas jetted from the gas nozzle presses the meniscus of the molten metal also changes, and the thinning of the plated layer becomes unstable. In order to control the height of the jetting port of the gas nozzle with respect to the liquid surface of the molten metal at a constant height, it is preferable that a gas jetting height detection means, which enables detection of such height, is provided. It is preferable that the height of the jetting port of the gas nozzle with respect to the liquid surface of the molten metal can be adjusted according to the detected height. Further, by allowing the height to be automatically adjusted by automatically detecting the height of the jetting port of the gas nozzle with respect to the liquid surface of the molten metal, the plated layer can stably be thinned, even when the molten metal in the plating tank is consumed and the liquid surface declines.

### Example

First, as an example of the present invention, an example wherein the gas nozzle 10 of FIG. 2 is used in the hot-dip apparatus of FIG. 1 will be described. In the present example, a lead-free solder (Sn—Ag—Cu alloy) layer is formed on the surface of a wire rod of copper foil sheet; however, the same effects can be obtained for wire rods with cross-sectional shapes other than a foil sheet, such as wire rods with a circular cross-section.

The wire rod used for the evaluation in the present example was a copper foil sheet obtained by slit processing a rolled copper foil of 0.2 mm thickness into a width of 2 mm. In the plating tank was pooled molten lead-free solder consisting of 3% Ag, 0.5% Cu, and remnant Sn, which was heated and melted so that the temperature of the liquid surface where the copper foil sheet is pulled up is 300° C.

The gas nozzle used in the present example comprised an outer tube part and an inner tube part of cylindrical shape, wherein the jetting port and the wire rod lead-out port were of a circular opening of 5 mmφ, and the distance (nozzle length) between the jetting port and the wire rod lead-out port was 30 mm. The distance between the jetting port and the molten lead-free solder liquid surface was set at 4 mm when installing the gas nozzle in an upright position on the hot-dip apparatus.

Further, during hot-dipping, the pull-up rate of the copper foil sheet was 6-24 m/min, the gas flow rate of the Ar gas introduced to the gas nozzle was 0-30 L/min, and the gas temperature was about 300° C. The total thickness of the copper foil sheet including the lead-free solder layer, after hot-dipping (plated foil sheet), was measured by a micrometer and microscopic observation of the cross-section of the copper foil sheet, and the average value was calculated from the total thickness at 5 points at the center of the foil sheet width.

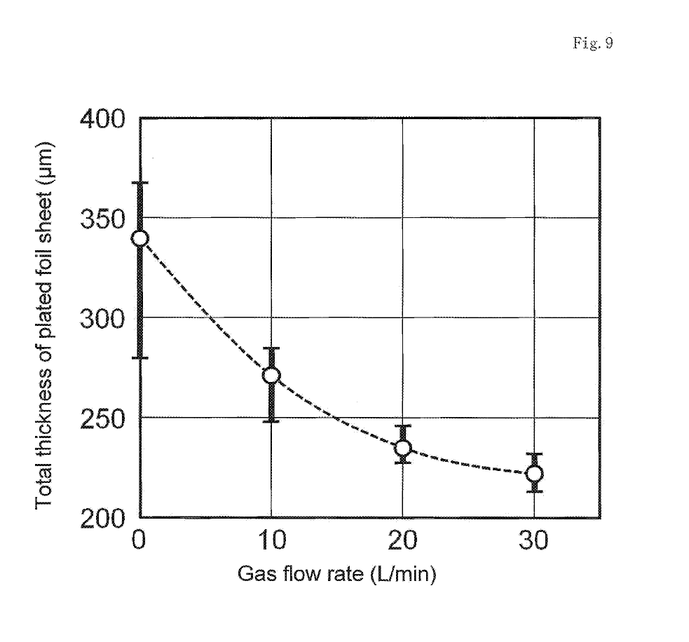

FIG. 9 shows the relationship between the total thickness of the plated foil sheet and the gas flow rate at a copper foil sheet pull-up speed of 10 m/min, and the circle marks indicate the average value of the total thickness of the plated foil sheet, the top and bottom bars indicate the maximum total thickness and the minimum total thickness. When the flow rate of the gas introduced to the gas nozzle was increased the total thickness of the plated foil sheet thinned, indicating that the gas jetted from the gas nozzle thinned the solder membrane thickness.

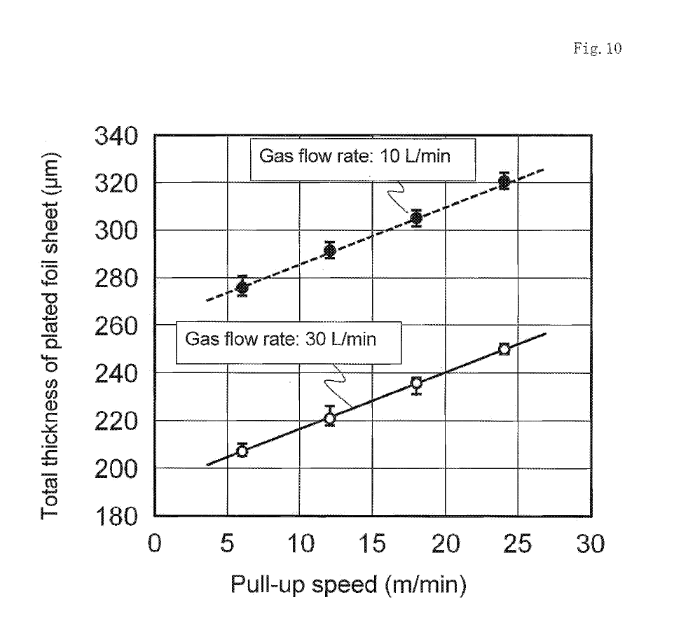

FIG. 10 shows the relationship between the total thickness of the plated foil sheet and the pull-up rate of the copper foil sheet when the flow rate of the gas introduced to the gas nozzle was set at 10 L/min and 30 L/min. At either flow rates, when the pull-up rate was increased, the total thickness of the plated foil sheet thickened. However, since the total thickness of the plated foil sheet could be made thinner at a condition of gas flow rate 30 L/min, it was shown that by increasing the flow rate of the gas introduced to the nozzle (jetting more amount of gas from the gas nozzle), the membrane thickness of the solder can be controlled so that it does not become thick, even when the copper foil sheet pull-up speed is increased.

### DESCRIPTION OF NOTATION

1: outer tube part
2: jetting port
2a: bottom cap
3: wire rod lead-out port
3a: top cap
4, 4a, 4b, 4a′, 4b′: gas introduction part
5: inner tube part
5a: support part
5b: bottom end
5c: top end
6, 6a, 6b, 6a′, 6b′: void part
7a, 7b: straightening plate
8: extraction tube
9: temperature sensor
10, 10a, 10b, 20, 20a, 20b, 20c: gas nozzle
80: conventional hot-dip apparatus
81: plating tank
82: sink roll
83: cover
84: gas source
85: piping
86: heater
100: hot-dip apparatus
101: plating tank
102: gas supply means
102a: gas supply source
102b: piping
103: sink roll
104: heater
105: differential pressure gauge
h: jetting height (distance)
θ, θ′: contact angle
A, B: movement direction of wire rod
G: gas
L: molten metal
M, M′: meniscus of molten metal
S: liquid surface of molten metal
W: wire rod

1. A gas nozzle for controlling plated membrane thickness that is used in hot-dipping of wire rods, which comprises:
an outer tube part that is provided in an upright position with respect to the liquid surface of a molten metal;
an inner tube part that is installed inside the outer tube part and comprises a cavity inside, through which the wire rod pulled up from the molten metal passes;
a void part formed between the outer tube part and the inner tube part;
a gas introduction part for introducing gas into the void part; and
a jetting port for jetting at least part of the gas that is introduced from the gas introduction part, via the void part, from one end of the outer tube part towards the liquid surface of the molten metal.

2. The gas nozzle for controlling plated membrane thickness of claim 1 comprising a wire rod lead-out port on the other end of the outer tube, wherein at least part of the gas introduced from the gas introduction part is discharged to the wire rod lead-out port, via the void part.

3. The gas nozzle for controlling plated membrane thickness of claim 1 comprising, in the void part, a straightening plate with multiple holes between the gas introduction part and the one end.

4. The gas nozzle for controlling plated membrane thickness of claim 2, wherein the straightening plate with multiple holes is installed on both the jetting port side and the wire rod lead-out port side, with respect to the gas introduction part.

5. The gas nozzle for controlling plated membrane thickness of claim 2, wherein the gas passage resistance from the gas introduction part to the jetting port is smaller than the gas passage resistance from the gas introduction part to the wire rod lead-out port.

6. The gas nozzle for controlling plated membrane thickness of claim 2, wherein:
the gas introduction part comprises a first gas introduction part and a second gas introduction part;
the void part is partitioned to a jetting port side and a wire rod lead-out side;
gas is introduced from the first gas introduction part to the void part of the jetting port side; and
gas is introduced from the second gas introduction part to the void part of the wire rod lead-out port side.

7. The gas nozzle for controlling plated membrane thickness of claim 6, wherein straightening plates with multiple holes are is installed between the first gas introduction part and the one end, and between the second gas introduction part and the other end.

8. A hot-dip apparatus for wire rods, which comprises:
the gas nozzle for controlling plated membrane thickness of claim 1, provided in an upright position with the jetting port facing the liquid surface of the molten metal;
a gas supply means for supplying gas to the gas introduction part of the gas nozzle for controlling plated membrane thickness; wherein
the wire rod pulled up from the molten metal passes through the cavity inside the inner tube part, and
the gas jetted from the jetting port presses the meniscus of the molten metal around the wire rod.

9. The hot-dip apparatus for wire rods of claim 8, wherein the gas supply means comprises a gas temperature adjustment means.

10. The hot-dip apparatus for wire rods of claim 8, which comprises a gas jetting height detection means for detecting gas jetting port height of the gas nozzle for controlling plated membrane thickness, with respect to the liquid surface of the molten metal.

11. The hot-dip apparatus for wire rods of claim 8, wherein:
the gas introduction part comprises a first gas introduction part and a second gas introduction part;
the void part is partitioned into the jetting port side and the wire rod lead-out side;
gas is introduced from the first gas introduction part to the void part of the jetting port side, and gas is introduced from the second gas introduction part to the void part of the wire rod lead-out side; and comprises
a differential pressure detection means for detecting the pressure difference between the pressure of the gas introduced from the first gas introduction part and the pressure of the gas introduced from the second gas introduction part.
